(19) United States
(12) Patent Application Publication
(10) Pub. No.: US 2026/0112003 A1
(43) Pub. Date: Apr. 23, 2026

(54) Systems and Methods for Cloud Removal from Satellite Images

(71) Applicant: Mitsubishi Electric Research Laboratories, Inc., Cambridge, MA (US)

(72) Inventors: Suhas Lohit, Arlington, MA (US); Tim Marks, Newton, MA (US)

(73) Assignee: Mitsubishi Electric Research Laboratories, Inc., Cambridge, MA (US)

(21) Appl. No.: 18/922,967

(22) Filed: Oct. 22, 2024

(51) Int. Cl. G06T 5/60; G06T 3/60; G06T 5/50

(52) U.S. Cl. CPC G06T 5/60; G06T 3/60; G06T 5/50; G06T 2207/10044; G06T 2207/20081; G06T 2207/20084

(57) ABSTRACT

An image processing method comprises collecting an aligned pair of an input optical image of a scene and a radar image of the scene and generating a multimodal image from the aligned pair of the input optical image and the radar image. The method further comprises submitting the multimodal image to a multimodal rotation-equivariant neural network to generate an estimate of the improved optical image of the scene. The multimodal rotation-equivariant neural network is configured such that a rotation of an input image to the neural network causes a corresponding rotation of an output image of the multimodal rotation-equivariant neural network. The method further comprises outputting the estimated improved optical image.

### TECHNICAL FIELD

The present disclosure relates generally to optical and radar image fusion, and more particularly for generating cloudless images from pairs of cloudy optical images and other satellite images that provide additional information using rotation-equivariant neural networks.

### BACKGROUND

Optical remote sensing imagery is at the core of many Earth observation activities. The regular, consistent and global-scale nature of satellite data is exploited in many applications, such as cropland monitoring, climate change assessment, land-cover and land-use classification, and disaster assessment. However, one problem that severely affects the temporal and spatial availability of surface observations is cloud cover. 70% of the Earth's surface is covered by clouds on average at any point of time. Clouds are an issue in remote sensing images as they can obscure the underlying ground features. This hinders the accuracy and effectiveness of remote sensing analysis, as the obscured regions cannot be properly interpreted. Thus, effective removal of clouds from satellite imagery is of vital importance.

Conventional techniques for detecting clouds in remote sensing images are mainly categorized into two groups: classical algorithms and deep learning approaches. While classical algorithms typically use thresholding-based techniques and hand-crafted features to identify cloud pixels, these techniques are limited in their accuracy and are sensitive to changes in image appearance and cloud structure. Deep learning approaches, on the other hand, mainly utilize convolutional neural networks (CNNs) to detect clouds in remote sensing images. These models are trained on large datasets of remote sensing images, allowing them to learn and generalize the unique features and patterns of clouds.

However, training these models is challenging as the cloud removal problem is ill-posed. Also, as the pair of cloudy and cloud-free images are from different times, the “ground truth” images are not suitable for training, which adds to the challenge of the problem. Furthermore, such approaches are not equivariant to rotations of the input image, which leads to lower robustness of these approaches. Therefore, there is still a need for systems and methods for recovering cloudless images from multimodal cloudy images.

### SUMMARY

Various example embodiments disclosed herein are directed towards deep learning-based approaches for image processing. In this regard, various example embodiments perform the deep learning-based image processing to recover images with reduced extent of cloud cover from cloudy images. In terms of depicting earth's surface, optical images are severely affected by the presence of clouds. However, it is a realization of some embodiments that unlike optical techniques, imaging techniques such as those based on radar can penetrate through clouds and provide some information about edges and materials that lie beneath the clouds. Thus, satellite images such as radar images can serve as important auxiliary information for remote sensing applications.

Some example embodiments are directed towards recovery of a cloudless or cloud free image of a scene from a combination of an aligned cloudy optical image and an additional satellite image such as a synthetic aperture radar image. It is a recognition of some example embodiments that satellite images generally have no preferred orientation. Some embodiments incorporate this insight into the design of a neural architecture by making the network layers obey the geometric constraint that the orientation of the input signal should not affect the quality of the reconstruction.

It is also a realization of various embodiments that features in satellite images can appear in any orientation. This fact stems from the inherent property of satellite images that they do not have any canonical or preferred orientations. As such, the output of the neural network should be of the same quality irrespective of the rotation applied to the input image. In terms of network architecture, this requirement translates to having constraints on each of the layers that they are rotation-equivariant. This means that a rotation applied to the input images should be reflected exactly in the output estimated image. Armed with this insight, some embodiments provide a multimodal rotation-equivariant network that takes cloud-penetrating radar images and cloudy optical images as input such that if the satellite image and the cloudy optical image rotate, all the intermediate feature maps as well as the output of the network rotate by the same amount. The neural network comprises a series of rotation-equivariant convolutional blocks, each of which includes rotation-equivariant group convolutional layers.

Example embodiments disclosed herein are directed towards providing a multimodal rotation-equivariant deep neural network for cloud removal in cloudy images. It is an object of some embodiments to provide such a neural network in which output of the neural network is of same quality irrespective of rotations applied to the input image to the network. Such a neural network has constraints on each of the layers whereby the constraints impose rotation equivariance on the layers. Thus, a rotation applied to the input images is reflected exactly in the estimated output image.

According to some embodiments, the input to the multimodal rotation-equivariant deep neural network includes a combination of a satellite image and a corresponding aligned cloudy optical image. The two images are concatenated in the channel dimension and fed to the multimodal rotation-equivariant deep neural network. The network comprises a series of rotation-equivariant convolutional blocks, each of which includes a rotation-equivariant group convolutional layers. The layers are designed by constraining the learned filters in each layer to obey the desired equivariance property. The resultant network has an architecture such that if the input images rotate, all the intermediate feature maps as well as the output of the network rotate by the same amount.

Some embodiments are directed towards Group equivariant Convolutional Neural Networks (G-CNNs) which are a natural generalization of convolutional neural networks that reduce sample complexity and improve performance by exploiting symmetries in data. These symmetries are described with respect to symmetry groups of transformations which satisfy the following mathematical properties. If two symmetry transformations g and h are composed, the result gh is another symmetry transformation. Furthermore, the inverse g⁻¹ of any symmetry is also a symmetry, and composing it with g gives the identity transformation e. A set of transformations with these properties is called a symmetry group. One example of such a symmetry group is the p4 group which comprises all compositions of translations and rotations by 90 degrees about any center of rotation in a square grid. Some example embodiments enforce equivariance to the p4 group where each element of the group is a composition of a translation T and rotation r∈{0, 90, 180, 270}degrees acting on a square 2D image grid. Accordingly, various example embodiments utilize convolutions that are equivariant to the p4 group. Such convolutions, which may also be referred to as rotation-equivariant convolutions, provide a good trade-off between benefits of equivariance and computational complexity for the cloud removal problem.

In order to achieve the aforementioned objectives and advantages, some example embodiments provide systems, methods and computer program products that effectively perform cloud removal in optical images with the aid of a corresponding aligned radar image. The approach followed in this regard is equivariant to rotations of the images and is faster than the conventional approaches for cloud removal.

Accordingly, some example embodiments provide an image processing system, comprising a memory configured to store computer-executable instructions and one or more processors configured to execute the instructions to collect an aligned pair of an input optical image of a scene and a radar image of the scene. The one or more processors are further configured to generate a multimodal image from the aligned pair of the input optical image and the radar image and submit the multimodal image to a multimodal rotation-equivariant neural network that generates the estimate of the improved optical image of the scene. The multimodal rotation-equivariant neural network is configured such that a rotation of an input image to the neural network causes a corresponding rotation of an output image of the multimodal rotation-equivariant neural network. The one or more processors are further configured to output the estimated improved optical image.

In yet another example embodiment, an image processing method is provided. The method comprises collecting an aligned pair of an input optical image of a scene and a radar image of the scene and generating a multimodal image from the aligned pair of the input optical image and the radar image. The method further comprises submitting the multimodal image to a multimodal rotation-equivariant neural network to generate an estimate of the improved optical image of the scene. The multimodal rotation-equivariant neural network is configured such that a rotation of an input image to the neural network causes a corresponding rotation of an output image of the multimodal rotation-equivariant neural network. The method further comprises outputting the estimated improved optical image.

In yet another example embodiment, a computer program product is provided. The computer program product comprises a non-transitory computer readable medium having stored thereon computer-executable instructions which when executed by a computer, cause the computer to perform an image processing method for cloud removal. The image processing method comprises collecting an aligned pair of an input optical image of a scene and a radar image of the scene and generating a multimodal image from the aligned pair of the input optical image and the radar image. The method further comprises submitting the multimodal image to a multimodal rotation-equivariant neural network to generate an estimate of the improved optical image of the scene. The multimodal rotation-equivariant neural network is configured such that a rotation of an input image to the neural network causes a corresponding rotation of an output image of the multimodal rotation-equivariant neural network. The method further comprises outputting the estimated improved optical image.

The multimodal rotation-equivariant neural network may comprise a first layer configured to generate a plurality of feature maps by executing one or more transformations on the multimodal image according to a symmetry group. The symmetry group comprises all compositions of translations and rotations by 90 degrees about any center of rotation in a square two-dimensional image grid. The multimodal rotation-equivariant neural network may further comprise a plurality of intermediate layers configured to perform group convolutions on the plurality of feature maps defined on the symmetry group. According to some embodiments, each intermediate layer of the plurality of intermediate layers maps a unique feature map of the plurality of feature maps to other feature maps of the plurality of feature maps. According to some embodiments, each second layer of the plurality of second layers has multiple input and multiple output channels. The multimodal rotation-equivariant neural network may further comprise a plurality of pooling layers configured to perform pooling of features along the rotation dimension of the multimodal image, which results in the rotation-equivariant estimate of the improved optical image.

### BRIEF DESCRIPTION OF THE DRAWINGS

The presently disclosed embodiments will be further explained with reference to the following drawings. The drawings shown are not necessarily to scale, with emphasis instead generally being placed upon illustrating the principles of the presently disclosed embodiments.

FIG. 1A illustrates a block diagram of an image processing system for cloud removal in optical images, according to some example embodiments;

FIG. 1B illustrates a flowchart of an image processing method for cloud removal in optical images, according to some example embodiments;

FIG. 2A shows an example of an equivariant function equivariant to translations and rotations, according to some example embodiments;

FIG. 2B shows an example of an invariant function equivariant to translations and rotations according to some example embodiments.

FIG. 3A illustrates a general architecture of a deep equivariant neural network with equivariant output;

FIG. 3B illustrates a general architecture of a deep equivariant neural network with invariant output;

FIG. 4 illustrates the equivariance of a two-layer Group equivariant Convolutional Neural Network in p4 symmetry group, according to some example embodiments;

FIG. 5 illustrates the architecture of a multimodal rotation-equivariant neural network, according to some example embodiments;

FIG. 6 illustrates the architecture of a convolution block of the multimodal rotation-equivariant neural network of FIG. 5, according to some example embodiments;

FIG. 7 illustrates a block diagram depicting application of the multimodal rotation-equivariant neural network of FIG. 5 for control tasks, according to some example embodiments; and

FIG. 8 shows some components of a computer system implementing the image processing system of FIG. 1A, according to some example embodiments.

While the above-identified drawings set forth presently disclosed embodiments, other embodiments are also contemplated, as noted in the discussion. This disclosure presents illustrative embodiments by way of representation and not limitation. Numerous other modifications and embodiments can be devised by those skilled in the art which fall within the scope and spirit of the principles of the presently disclosed embodiments.

### DETAILED DESCRIPTION

The following description provides exemplary embodiments only, and is not intended to limit the scope, applicability, or configuration of the disclosure. Rather, the following description of the exemplary embodiments will provide those skilled in the art with an enabling description for implementing one or more exemplary embodiments. Contemplated are various changes that may be made in the function and arrangement of elements without departing from the spirit and scope of the subject matter disclosed as set forth in the appended claims.

Specific details are given in the following description to provide a thorough understanding of the embodiments. However, as understood by one of ordinary skill in the art, the embodiments may be practiced without these specific details. For example, systems, processes, and other elements in the subject matter disclosed may be shown as components in block diagram form in order not to obscure the embodiments in unnecessary detail. In other instances, well-known processes, structures, and techniques may be shown without unnecessary detail in order to avoid obscuring the embodiments. Further, like-reference numbers and designations in the various drawings may indicate like elements.

Also, individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process may be terminated when its operations are completed but may have additional steps not discussed or included in a figure. Furthermore, not all operations in any particularly described process may occur in all embodiments. A process may correspond to a method, a function, a procedure, a subroutine, a subprogram, etc. When a process corresponds to a function, the function's termination can correspond to a return of the function to the calling function or the main function.

Furthermore, embodiments of the subject matter disclosed may be implemented, at least in part, either manually or automatically. Manual or automatic implementations may be executed, or at least assisted, through the use of machines, hardware, software, firmware, middleware, microcode, hardware description languages, or any combination thereof. When implemented in software, firmware, middleware or microcode, the program code or code segments to perform the necessary tasks may be stored in a machine-readable medium. A processor(s) may perform the necessary tasks.

Cloud removal in images, especially satellite and remote sensing imagery, is a crucial task for improving the quality of data for applications like land cover mapping, agricultural monitoring, and environmental studies. The large and sustained amount of coverage of Earth's surface by clouds hinders important remote sensing applications that use optical images in areas such as disaster management, agriculture, and ecological monitoring. Thus, being able to effectively remove clouds from satellite imagery is of importance. While optical images are affected by the presence of clouds, radar can penetrate through clouds and provide some information about edges and materials that lie beneath the clouds, providing important side information for remote sensing applications.

Some solutions generate cloud masks that can be used to identify the cloud pixels and eliminate them from further analysis. Another solution includes using cloud inpainting techniques to fill in the gaps left by the clouds. This approach helps to improve the accuracy of remote sensing analysis and provides a clearer view of the ground, even in the presence of clouds. However, such approaches typically use threshold-based techniques and hand-crafted features to identify cloud pixels. Therefore, these techniques are limited in their accuracy and are sensitive to changes in image appearance and cloud structure. Recently, deep learning approaches have shown great promise in handling cloud removal tasks by learning to predict and reconstruct the missing or occluded areas due to clouds based on available information. For example, one approach in this regard utilizes large training datasets generated by combining multispectral data and satellite imagery data from different times and using multimodal registration. Such large datasets come as triplets of aligned images (radar, cloudy optical, and cloud-free optical images). By treating the cloud-free optical images as ground truth, these datasets may be used to train large supervised deep learning models. However, even with large datasets, the problem remains challenging, especially when there is significant cloud cover. Since the cloudy and cloud-free images in the datasets were captured at different times, the cloud-free images do not provide a perfect ground truth for the cloudy images that are used for training the neural networks, which adds to the challenge of the problem.

Various example embodiments described herein perform the deep learning-based image processing to recover images with reduced extent of cloud cover from cloudy images. Some example embodiments are directed towards recovery of a cloudless or cloud free image of a scene from a combination of an aligned cloudy optical image and a satellite image such as a synthetic aperture radar image. It is a recognition of some example embodiments that satellite images generally have no preferred orientation. Some embodiments incorporate this insight into the design of a neural architecture by making the network layers obey the geometric constraint that the orientation of the input signal should not affect the quality of the reconstruction. As such, the output of the neural network should be of the same quality irrespective of the rotation applied to the input image. In terms of network architecture, this requirement translates to having constraints on each of the layers that they are rotation-equivariant. This means that a rotation applied to the input images should be reflected exactly in the output estimated image. Armed with this insight, some embodiments provide a multimodal rotation-equivariant network that takes satellite images and cloudy optical images as input such that if the satellite image and the cloudy optical image rotate, all the intermediate feature maps as well as the output of the network rotate by the same amount.

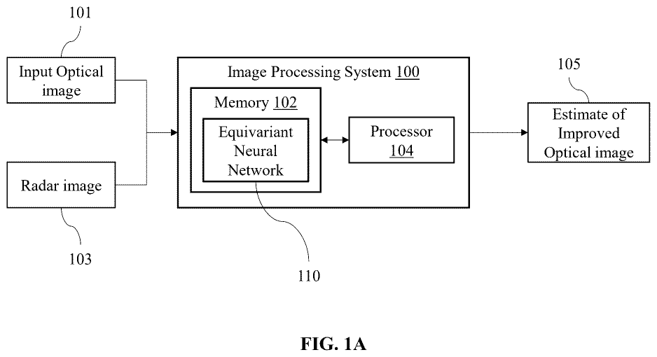

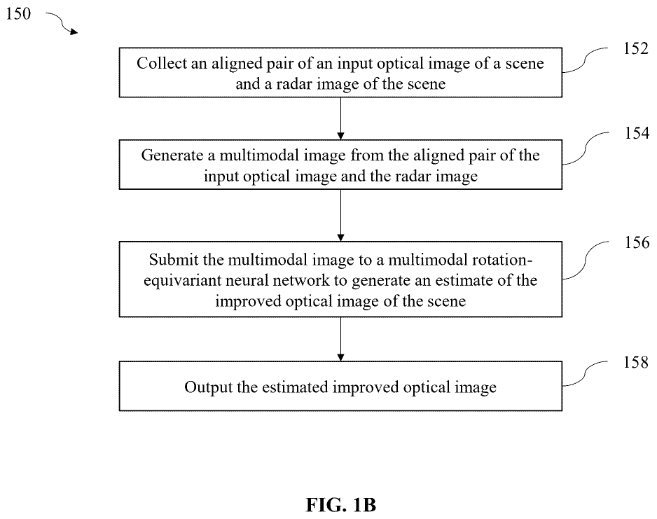

FIG. 1A illustrates an image processing system 100 for recovering an image with reduced extent of cloud cover (also referred to as cloudless image 105 or estimate improved optical image 105) from an aligned pair of an optical image 101 and a radar image 103 of a scene. The image processing system 100 may be embodied as a computing apparatus comprising a memory 102 and one or more processors 104 (hereinafter, also referred to as a processor). The processor 104 reads data and program from the memory 102 to perform the recovery of cloudless images. The memory stores amongst other things, a multimodal rotation-equivariant neural network 110 that is trained to reduce the extent of cloud cover in the input provided to it. In this regard, the neural network 110 is configured such that a rotation of an input image to the neural network causes a corresponding rotation of an output image of the multimodal rotation-equivariant neural network.

As is illustrated in FIG. 1B, in operation, the image processing system 100 executes a method 150 for generating the cloudless images of a scene. The method 150 comprises collecting 152 an aligned pair of an input optical image 101 of a scene and a radar image 103 of the scene. A multimodal image is generated 154 from the aligned pair of the input optical image (cloudy) and the radar image. In this regard, the two inputs are concatenated in the channel dimension and fed/submitted 156 to the multimodal rotation-equivariant neural network 110 to generate an estimate of the improved optical image 105 of the scene. The neural network 110 comprises a series of rotation equivariant convolutional blocks, each of which includes a of rotation-equivariant group convolutional layers. The method further comprises outputting 158 the estimated improved optical image 105.

Equivariant neural networks are a class of neural networks designed to respect symmetries in data. Unlike traditional neural networks, which treat input features independently, equivariant networks ensure that the learned features transform in predictable ways when the input undergoes certain transformations (like rotations, translations, or reflections). In image processing tasks, objects can appear in different orientations (rotated or flipped) and thus exhibit symmetry. A network is said to be equivariant to a transformation if, when the input data undergoes that transformation, the output also transforms in a corresponding way. Mathematically, let ƒ be a function (the neural network), and let Tₓ and T_{y} be transformations applied to the input and output respectively. The network is equivariant if:

$$f ( {T}_{x} ( x ) ) = {T}_{y} ( f ( x ) )$$

This means applying the transformation to the input and then feeding it through the network is equivalent to feeding the input through the network and then transforming the output. Thus, with equivariant networks, the output changes in a predictable way when the input is transformed. For example, if the input is rotated, the output may also rotate. In contrast, with invariant networks, the output remains the same despite transformations in the input. For example, if the input is rotated, the output remains unchanged. Unlike equivariant and invariant neural networks, conventional neural networks are not trained with either of the constraints, which often results in unpredictability in network outputs.

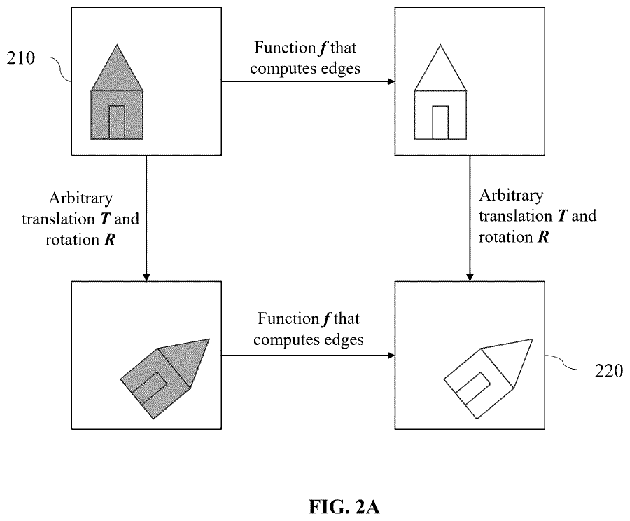

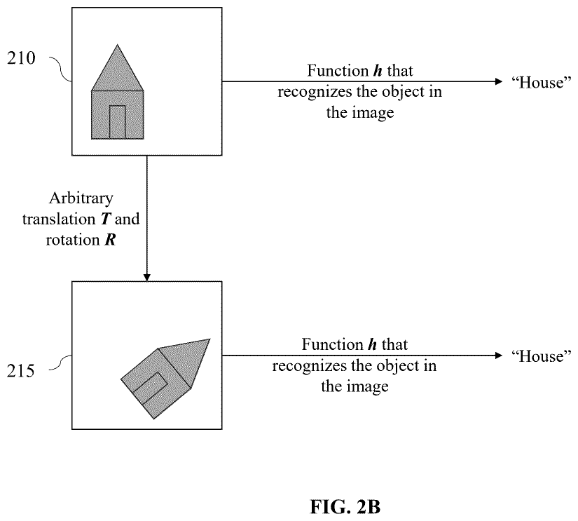

FIG. 2A shows an example of an equivariant function equivariant to translations and rotations, according to some embodiments. The figure illustrates group equivariance through an example that shows an example of equivariance to translations and rotations. Here, the function ƒ is equivariant to translations and rotations. The translation and rotation applied at the input image 210 is reflected at the output image 220. The function that computes edges in an image is denoted as ƒ, then it is desirable in some embodiments that when input rotates, the edge map output from ƒ also rotates by the same amount. That means that the function ƒ should be equivariant to rotations.

The types of transformations for which a network can be equivariant are often described using group theory. A group is a mathematical concept that defines a set of transformations and how they can be combined. Examples include translation group (the group of shifts in space (handled by convolutional neural networks, or CNNs)), rotation group (the group of rotations around an axis), and reflection group (the group of flipping or mirroring an object). Equivariant neural networks are designed to be equivariant with respect to certain transformation groups. For instance, CNNs are equivariant to translations because a convolution preserves the spatial relationship of features across different locations in the image. In general, a function ƒ that takes in inputs x belonging to a set X, is equivariant to a group G, if for all g in the group G, we have ƒ(g(x))=g(ƒ(x)).

FIG. 2B shows an example of an invariant function invariant to translations and rotations according to some embodiments. The figure illustrates the concept of group invariance, showing an example of invariance to translations and rotations that result into transformed image 215. Here, the function h recognizes the object in the image, and is invariant to translations and rotations. The output of h is the same irrespective of the input translation and rotation applied to the input image 210. As the example, consider the application of image recognition. The identified object in the image 210 is the same irrespective of the rotation and/or translation applied at the input. That is the image classification function h should be invariant to input rotations and translations. In general, for a set of inputs X whose elements are denoted as x, and a group G whose elements are denoted as g, a function h is invariant to the action of G if for all x belonging to X, for all g belonging to G, h(g(x))=h(x).

Group equivariance and invariance are properties for designing robust machine learning systems that use neural networks. Group equivariance plays a role in the success of several popular architectures such as translation equivariance in Convolutional Neural Networks (CNNs) for image processing, 3D rotational equivariance for point clouds, and equivariance to arbitrary groups in Group Convolutional Neural Networks (GCNNs).

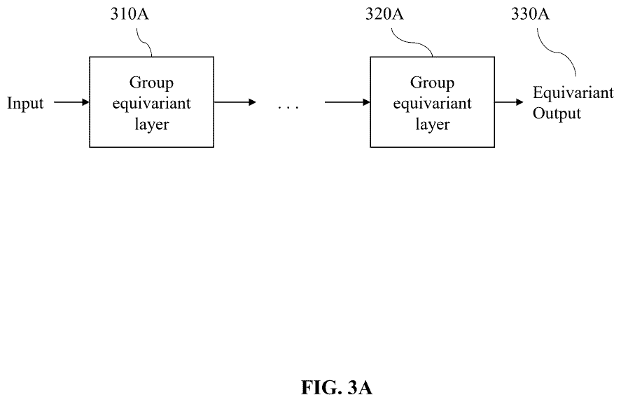

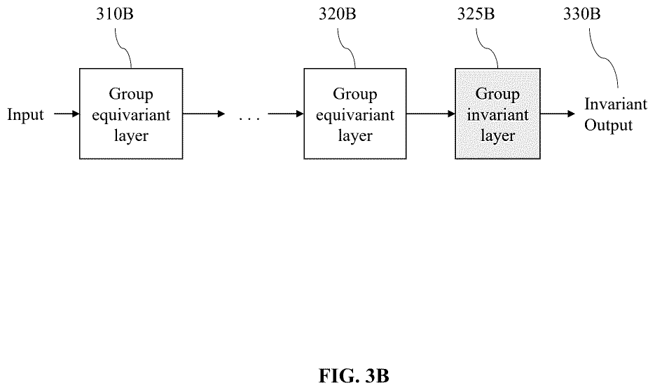

FIG. 3A and FIG. 3B show the general architecture for deep equivariant neural networks. FIG. 3A illustrates a general architecture of a deep equivariant neural network with equivariant output 330A. Each layer 310A, 320A of an equivariant neural network is equivariant to a group of transformations. FIG. 3B illustrates a general architecture of a deep equivariant neural network with invariant output 330B. Each layer 310B, 320B of the equivariant neural network is equivariant to a group of transformations. Invariance at the output can be achieved by pooling over the group dimensions in the output. Such a neural network includes multiple layers, each of which is equivariant to the group of interest. When equivariant layers are stacked one after the other, the output of the stack is still equivariant to the group. If invariance is needed at the output, an additional layer 325B, usually a pooling layer, is added to pool the outputs over the group dimension to create the invariant output.

Some example embodiments design the neural network 110 of FIG. 1A by modifying the traditional layers (such as convolutions) so that they respect the symmetries in the data. In this regard, some embodiments use group convolutions instead of regular convolutions. These convolutions are designed to act on inputs and outputs defined over a group.

Some embodiments are directed towards Group equivariant Convolutional Neural Networks (G-CNNs) which are a natural generalization of convolutional neural networks and that reduce sample complexity by exploiting symmetries in data. These symmetries are described with respect to symmetry groups of transformations which satisfy the following mathematical properties. If two symmetry transformations g and h are composed, the result gh is another symmetry transformation. Furthermore, the inverse g⁻¹ of any symmetry is also a symmetry, and composing it with g gives the identity transformation e. A set of transformations with these properties is called a symmetry group. One example of such a symmetry group is the p4 group which comprises all compositions of translations and rotations by 90 degrees about any center of rotation in a square grid. Some example embodiments enforce equivariance to the p4 group where each element of the group is a composition of a translation T and rotation r∈{0, 90, 180, 270}degrees acting on a square 2D image grid. Accordingly, various example embodiments utilize convolutions that are equivariant to the p4 group. Such convolutions, which may also be referred to as rotation-equivariant convolutions, provide a good trade-off between benefits of equivariance and computational complexity for the cloud removal problem.

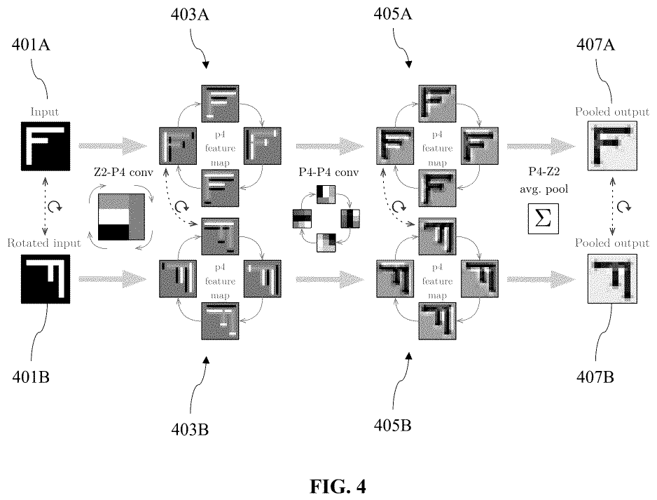

FIG. 4 illustrates the equivariance of a two-layer Group equivariant Convolutional Neural Network in p4 symmetry group, according to some example embodiments. The CNN is considered to have a first layer that performs lifting convolution on the input image to generate a feature map and one or more second layers that perform group convolutions on the feature map. The Z2→p4 convolution (lifting convolution) correlates the input image 401A or 401B with four rotated versions of the same kernel. Referring to the schematics of FIG. 4, this may be understood as the filter being rotated by 90 degrees each time and the resultant image (filtered) being convoluted with the input image 401A or 401B. This lifting convolution results in generation of a feature map 403A or 403B, for the input image 401A or 401B, respectively. The feature map 403A or 403B is a function of the 2D space as well as the rotation group, therefore this feature map is a function on the p4 group.

The p4→p4 convolution (group convolution) correlates the resulting feature map 403A or 403B with the p4-kernel, cyclically shifting and rotating the kernel for each orientation in the input feature map and performing the correlation across both the 2D translation and rotation dimensions. This may be understood as each 2D feature map in 403A or 403B subjected to regular convolution with four different filters and the outputs being added to obtain one 2D image of the feature map 405A or 405B as the case may be. Thereafter, the four filters are jointly rotated by 90 degrees and cyclically shifted, and the feature map 403A or 403B is subjected to regular convolution with the rotated four different filters and the outputs being combined to obtain the next 2D image of the feature map 405A or 405B, and the process repeated till all joint rotations and cyclic shifts are exhausted. Thus, the output feature map 405A or 405B will also be a feature map defined on the p4 group.

The final layer performs average pooling over the orientations, i.e., add the feature values over the four rotations for each 2D location producing a representation 407A or 407B that is locally invariant and globally equivariant to rotation.

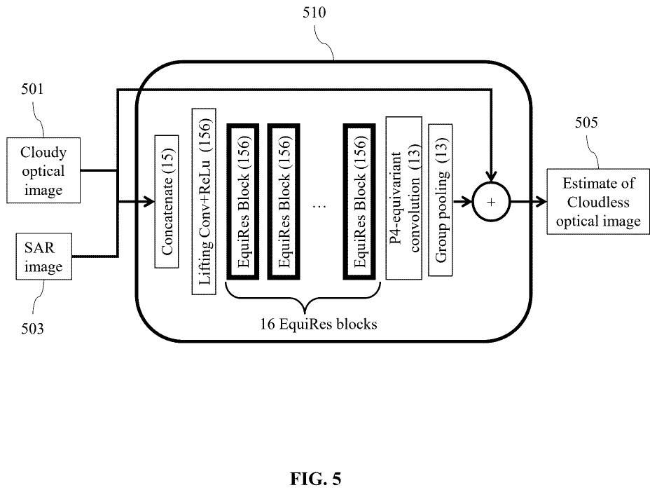

FIG. 5 illustrates the architecture of a multimodal rotation-equivariant neural network 510, according to some example embodiments. The layers of the neural network 510 have multiple input and output channels. As is shown against each layer, the number in the parentheses shows the number of channels in the output of that layer. The neural network 510 comprises a concatenate layer, a lifting convolution and ReLU layer, sixteen EquiRes blocks, a regular convolution layer, and a group pooling layer. The concatenate layer concatenates the input images 501 and 503 in the channel dimension and feeds the concatenated image to the lifting convolution and ReLU layer to perform Z2→p4 lifting convolution on the concatenated image. The lifting convolution is given by:

$${x}_{{c}^{′}}^{( 1 )} = [ x * {ψ}^{( 1 )} ] ( g ) = {\sum }_{c ∈ {C}_{0}} {\sum }_{τ ∈ {ℤ}^{2}} {x}_{c} ( τ ) {{ψ}_{c}}^{( 1 )} ( {g}^{- 1} τ )$$

where g is an element of the p4 group. C₀ is the number of channels in the input to the network and C₁ is the number of channels in output feature maps of the first layer. In the present cloud removal application, the input is a concatenated image of the cloudy optical multispectral image that has 13 color channels and the synthetic aperture radar (SAR) image that has 2 channels, making a total of 15 channels. Note that the output of this layer is a feature defined on the p4 group. In an example embodiment, this layer also increases the channel dimension from C₀=15 to C₁=156.

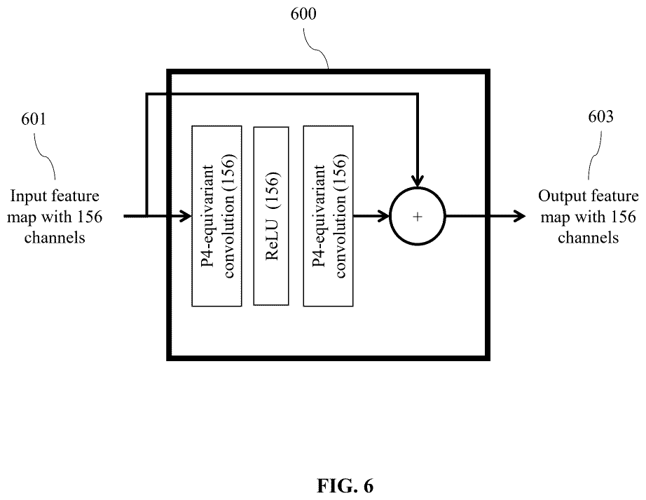

After the lifting convolution, the feature map is further processed through a series of EquiRes Blocks including p4→p4 group convolutions, described in detail in FIG. 6. The output of the EquiRes blocks is a feature map x^{L-1} that is still defined on the p4 group with C_{L-1} channels. In an example embodiment, C_{L-1}=156.

Another p4-p4 group convolution is used to map the feature x^{L-1} to x^{L} with C_{L} channels where C_{L} is the same number as the number of channels in the desired output. In the present cloud removal application, the desired output is the cloud-free multispectral optical image with 13 color channels.

Finally, to create an equivariant output given features on the p4 group, pooling is performed along the rotation dimension. The pooled output is added to the input multispectral optical image, which is also referred to as a residual connection, to create the final equivariant output of the multimodal rotation-equivariant network:

$$y ( τ ) = x ( τ ) + {\sum }_{r ∈ \{ 0 , 90 , 180 , 270 \}} {x}^{L} ( τ , r )$$

For training of the network, the Mean Absolute Error (L1 Loss) between the estimated cloud-free image y and the ground-truth y may be used with mini-batch gradient descent based on the training dataset and using backpropagation to learn the parameters in all the learnable filters in the network

$$Loss = \frac{1}{B} {\sum }_{j = 1}^{B} {‖ {y}^{( j )} - {\hat{y}}^{( j )} ‖}_{1}$$

where B is the number of examples in a batch.

FIG. 6 illustrates the architecture of an EquiRes block 600 of the multimodal rotation-equivariant neural network 510 of FIG. 5, according to some example embodiments.

In an example embodiment, the EquiRes block maps a feature map defined on the p4 group to another feature map defined on the p4 group in an equivariant fashion. The EquiRes block comprises two p4→p4 group convolution layers with a pointwise ReLU nonlinearity layer in-between, as well as a residual connection that adds the input feature map to the output of the second group convolution layer, to form the output feature map of the EquiRes block.

The p4→p4 group convolution layers map feature maps defined on the p4 group to other feature maps on p4 group. This is given by:

$${x}_{{c}^{′}}^{( l + 1 )} = [ {x}^{l} * {ψ}^{( l )} ] ( g ) = {\sum }_{c ∈ {C}_{l}} {\sum }_{h ∈ p 4} {x}_{c}^{l} ( h ) {{ψ}_{c}}^{( l )} ( {g}^{- 1} h )$$

Cₗ and Cₗ₊₁ are the number of channels in layers l and l+1. Additionally, pointwise nonlinearities like Rectified Linear Units (ReLUs) are included between any two convolutional layers, except the last one and residual connections that maintain the required p4-equivariance are also included in some example embodiments. Optionally, some normalization layers that maintain the required p4-equivariance can also be included in the group convolutional neural network architecture.

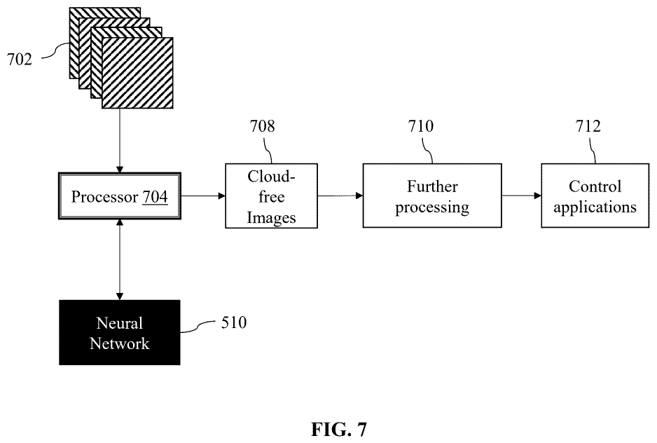

FIG. 7 illustrates a block diagram depicting application of the multimodal rotation-equivariant neural network of FIG. 5 for control tasks, according to some example embodiments. Aligned pairs 702 of a cloudy optical image of a scene and a radar image such as a synthetic aperture radar image of a scene may be provided as an input to a processor 704 for reducing or removing the cloud cover in the optical image. For example, the optical and radar images may be captured by different image capturing devices. The processor 704 may invoke the multimodal rotation-equivariant neural network 510 to perform cloud removal in accordance with the framework described with respect to the previous figures. The processor 704 may thus output cloudless or cloud-free images 708 that have an extent of cloud cover lower than that in the input optical image. These images may be further processed at block 710 to extract information and content from the cloudless images 708 that are utilized to generate control commands for one or more control applications 712. The control applications 512 may include for example controlling an emergency responder robot in an area hit by a disaster or calamity.

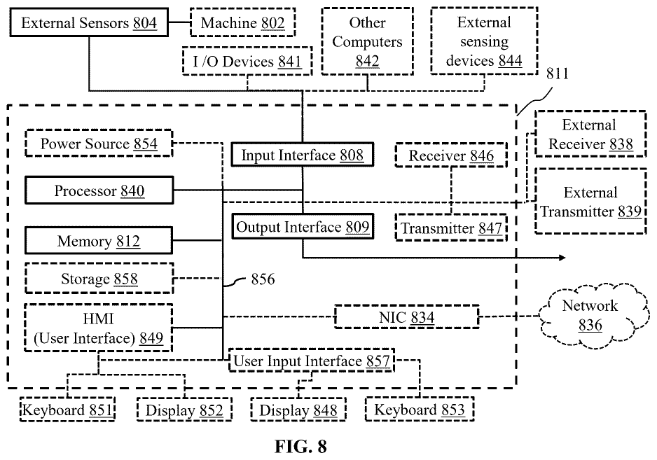

FIG. 8 illustrates some components of a computer system implementing the image processing system of FIG. 1A, according to some example embodiments. The computer 811 includes a processor 840, computer readable memory 812, storage 858 and user interface 849 with display 852 and keyboard 851, which are connected through bus 856. For example, the user interface 864 in communication with the processor 840 and the computer readable memory 812, acquires and stores the image data in the computer readable memory 812 upon receiving an input from a surface, keyboard 853, of the user interface 857 by a user.

The computer 811 can include a power source 854, depending upon the application the power source 854 may be optionally located outside of the computer 811. Linked through bus 856 can be a user input interface 857 adapted to connect to a display device 848, wherein the display device 848 can include a computer monitor, camera, television, projector, or mobile device, among others. A printer interface 859 can also be connected through bus 856 and adapted to connect to a printing device 832, wherein the printing device 832 can include a liquid inkjet printer, solid ink printer, large-scale commercial printer, thermal printer, UV printer, or dye-sublimation printer, among others. A network interface controller (NIC) 834 is adapted to connect through the bus 856 to a network 836, wherein image data or other data, among other things, can be rendered on a third-party display device, third party imaging device, and/or third-party printing device outside of the computer 811.

Still referring to FIG. 8, the image data or other data, among other things, may be transmitted over a communication channel of the network 836, and/or stored within the storage system 858 for storage and/or further processing. Further, the time series data or other data may be received wirelessly or hard wired from a receiver 846 (or external receiver 838) or transmitted via a transmitter 847 (or external transmitter 839) wirelessly or hard wired, the receiver 846 and transmitter 847 are both connected through the bus 856. The computer 811 may be connected via an input interface 808 to external sensing devices 844 and external input/output devices 841. For example, the external sensing devices 844 may include sensors gathering data before-during-after of the collected time-series data of the machine. The computer 811 may be connected to other external computers 842. An output interface 809 may be used to output the processed data from the processor 840. It is noted that a user interface 849 in communication with the processor 840 and the non-transitory computer readable storage medium 812, acquires and stores the region data in the non-transitory computer readable storage medium 812 upon receiving an input from a touch surface of the display 852 of the user interface 849 by a user.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine. Typically, the functionality of the program modules may be combined or distributed as desired in various embodiments.

The above description provides exemplary embodiments only, and is not intended to limit the scope, applicability, or configuration of the disclosure. Rather, the above description of the exemplary embodiments will provide those skilled in the art with an enabling description for implementing one or more exemplary embodiments. Contemplated are various changes that may be made in the function and arrangement of elements without departing from the spirit and scope of the subject matter disclosed as set forth in the appended claims.

Specific details are given in the above description to provide a thorough understanding of the embodiments. However, understood by one of ordinary skill in the art can be that the embodiments may be practiced without these specific details. For example, systems, processes, and other elements in the subject matter disclosed may be shown as components in block diagram form in order not to obscure the embodiments in unnecessary detail. In other instances, well-known processes, structures, and techniques may be shown without unnecessary detail in order to avoid obscuring the embodiments. Further, like reference numbers and designations in the various drawings indicated like elements.

Also, individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process may be terminated when its operations are completed but may have additional steps not discussed or included in a figure. Furthermore, not all operations in any particularly described process may occur in all embodiments. A process may correspond to a method, a function, a procedure, a subroutine, a subprogram, etc. When a process corresponds to a function, the function's termination can correspond to a return of the function to the calling function or the main function.

Furthermore, embodiments of the subject matter disclosed may be implemented, at least in part, either manually or automatically. Manual or automatic implementations may be executed, or at least assisted, through the use of machines, hardware, software, firmware, middleware, microcode, hardware description languages, or any combination thereof. When implemented in software, firmware, middleware or microcode, the program code or code segments to perform the necessary tasks may be stored in a machine readable medium. A processor(s) may perform the necessary tasks.

Various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine. Typically, the functionality of the program modules may be combined or distributed as desired in various embodiments.

Embodiments of the present disclosure may be embodied as a method, of which an example has been provided. The acts performed as part of the method may be ordered in any suitable way. Accordingly, embodiments may be constructed in which acts are performed in an order different than illustrated, which may include performing some acts concurrently, even though shown as sequential acts in illustrative embodiments. Although the present disclosure has been described with reference to certain preferred embodiments, it is to be understood that various other adaptations and modifications can be made within the spirit and scope of the present disclosure. Therefore, it is the aspect of the append claims to cover all such variations and modifications as come within the true spirit and scope of the present disclosure.

What is claimed is:

1. An image processing system, comprising: a memory configured to store computer-executable instructions; and one or more processors configured to execute the instructions to:
collect an aligned pair of an input optical image of a scene and a radar image of the scene;
generate a multimodal image from the aligned pair of the input optical image and the radar image;
submit the multimodal image to a multimodal rotation-equivariant neural network to generate an estimate of an improved optical image of the scene, wherein the multimodal rotation-equivariant neural network is configured such that a rotation of an input image to the neural network causes a corresponding rotation of an output image of the multimodal rotation-equivariant neural network; and
output the estimated improved optical image.

2. The system of claim 1, wherein the input optical image comprises a first proportion of pixels corresponding to clouds and the estimated improved optical image comprises a second proportion of pixels corresponding to clouds, and wherein the second proportion is less than the first proportion.

3. The system of claim 1, wherein the one or more processors are configured to generate the estimated improved optical image as a cloud-free optical image.

4. The system of claim 1, wherein the multimodal rotation-equivariant neural network comprises:
a first layer configured to perform a lifting convolution that transforms a multimodal image to a feature map defined on a symmetry group;
a plurality of intermediate layers configured to perform group convolutions on a plurality of feature maps defined on the symmetry group; and
a pooling layer configured to perform pooling along a rotation dimension of a penultimate feature map to yield the network output that is rotation-equivariant.

5. The system of claim 4, wherein the symmetry group comprises all compositions of translations and rotations by 90 degrees about any center of rotation in a square two-dimensional image grid.

6. The system of claim 4, wherein each intermediate layer of the plurality of intermediate layers maps a unique feature map of the plurality of feature maps to other feature maps of the plurality of feature maps.

7. The system of claim 4, wherein each intermediate layer of a plurality of second layers has multiple input and multiple output channels.

8. The system of claim 4, wherein the multimodal rotation-equivariant neural network is trained to minimize a mean absolute error loss computed between the network output and a cloudless optical image based on ground truth data in a training dataset.

9. An image processing method, comprising:
collecting an aligned pair of an input optical image of a scene and a radar image of the scene;
generating a multimodal image from the aligned pair of the input optical image and the radar image;
submitting the multimodal image to a multimodal rotation-equivariant neural network to generate an estimate of an improved optical image of the scene, wherein the multimodal rotation-equivariant neural network is configured such that a rotation of an input image to the neural network causes a corresponding rotation of an output image of the multimodal rotation-equivariant neural network; and
outputting the estimated improved optical image.

10. The image processing method of claim 9, wherein the input optical image comprises a first proportion of pixels corresponding to clouds and the estimated improved optical image comprises a second proportion of pixels corresponding to clouds, and wherein the second proportion is less than the first proportion.

11. The image processing method of claim 9, wherein the estimated improved optical image is an estimate of a cloud-free optical image corresponding to an input cloudy optical image.

12. The image processing method of claim 9, further comprising:
performing, via a first layer of the multimodal rotation-equivariant neural network, a lifting convolution that transforms a multimodal image to a feature map defined on a symmetry group;
performing, via a plurality of intermediate layers of the multimodal rotation-equivariant neural network, on a plurality of feature maps defined on the symmetry group; and
performing, via a pooling layer of the multimodal rotation-equivariant neural network, pooling along a rotation dimension of a penultimate feature map to yield the network output that is rotation-equivariant.

13. The image processing method of claim 12, wherein the symmetry group comprises all compositions of translations and rotations by 90 degrees about any center of rotation in a square two-dimensional image grid.

14. The image processing method of claim 12, wherein each intermediate layer of the plurality of intermediate layers maps a unique feature map of the plurality of feature maps to other feature maps of the plurality of feature maps.

15. The image processing method of claim 12, wherein each intermediate layer of the plurality of intermediate layers has multiple input and multiple output channels.

16. A non-transitory computer readable medium having stored thereon computer-executable instructions which when executed by a computer, cause the computer to perform an image processing method for cloud removal, the method comprising:
collecting an aligned pair of an input optical image of a scene and a radar image of the scene;
generating a multimodal image from the aligned pair of the input optical image and the radar image;
submitting the multimodal image to a multimodal rotation-equivariant neural network to generate an estimate of an improved optical image of the scene, wherein the multimodal rotation-equivariant neural network is configured such that a rotation of an input image to the neural network causes a corresponding rotation of an output image of the multimodal rotation-equivariant neural network; and
outputting the estimate of the improved optical image.
